(19) United States
(12) Patent Application Publication
(10) Pub. No.: US 2003/0191775 A1
(43) Pub. Date: Oct. 9, 2003

(54) Software identification system and method

(76) Inventors: Robert D. Vaughan, Eagle, ID (US); Jeroen Pieter Van Alphen, Leiden (NL)

Correspondence Address: HEWLETT-PACKARD COMPANY, Intellectual Property Administration, P.O. Box 272400, Fort Collins, CO, 80527-2400, US

(21) Appl. No.: 10/116,376

(22) Filed: Apr. 3, 2002

(51) Int. Cl. G06F 7/00; G06F 17/30; G06F 15/16

(52) U.S. Cl. 707/104.1; 707/3; 709/201

(57) ABSTRACT

A system and method that facilitates convenient and efficient identification of software is disclosed. A query that includes an indication of requested software characteristics is received by a software identification system. Software corresponding to the requested software characteristics is identified. The software identification system transmits information describing the software to a device that issued the query.

### TECHNICAL FIELD

The present invention relates to software distribution.

### BACKGROUND ART

Electronic systems and circuits have made a significant contribution towards the advancement of modern society and are utilized in a number of applications to achieve advantageous results. Numerous electronic technologies such as digital computers, calculators, audio devices, video equipment, and telephone systems have facilitated increased productivity and reduced costs in analyzing and communicating data, ideas and trends in most areas of business, science, education and entertainment. Frequently, these advantageous results are realized through the use of software stored on a memory media and implemented by a processing device. Selecting and accessing appropriate software directed to producing desired results is often very cumbersome and complicated.

Software typically includes information utilized in the performance of a multitude of tasks directed towards providing a variety of results. For example, software is often used to control and direct device operations in a computer system. Software requirements for different systems typically vary and are seldom static. For example, most computer systems are not configured with identical components and the different components (e.g., printers, network cards, video cards, etc.) usually require different software device drivers. When a device is added to a system an appropriate device driver is required to be installed to enable the operating system to manage the device. New software is also often required to be added to a system to take advantage of advances in technology or provide functions included in new software programs.

Determining appropriate software for the performance of a task and successfully installing the software are activities requiring a relatively high degree of precision and accuracy. Choosing and loading an appropriate software application typically involves significant user interaction that often requires extensive specialized knowledge beyond the range of general user experience. For example, selected software usually has to coherently interact with very specific individual idiosyncrasies of numerous different devices. There are also numerous different functions a user may desire to implement and picking software capable of providing maximized results is usually very difficult. Selecting appropriate software and correctly installing it are usually critical to accomplishing desired results.

Providing users with a wide assortment of software and an opportunity for maximizing satisfaction with desired functionality is important. Centralized storage with access over a network for downloading of particularly desired software to distributed resources usually provides some advantages and relieves individual distributed systems from managing extraneous information. Traditional attempts at accessing software via a network system typically require the user to determine appropriate software, manage the software communication (e.g., via a file transfer protocol, hyper text transfer protocol, etc.) and install the software properly. Each of these activities are usually very susceptible to user error and users typically have difficulty with activities such as figuring out the system hardware with sufficient specificity, accurately conveying correct information in a communication protocol, and executing the proper instructions to install the software. Prior attempts at addressing software distribution usually involve the dissemination of information consisting of highly technical brief statements beyond the comprehension of the average user and offer little practical guidance.

Thus, the prior art requires a user to interpret complicated information and expend significant resources shifting through large amounts of software information attempting to identify software that is compatible with a target device and provides desired functionality.

### DISCLOSURE OF THE INVENTION

A system and method that facilitates convenient and efficient identification of software is disclosed. A query that includes an indication of requested software characteristics is received by a software identification system. Software corresponding to the requested software characteristics is identified. The software identification system transmits information describing the software to a device that issued the query.

### BRIEF DESCRIPTION OF THE DRAWINGS

FIG. 1 is a flow chart showing a software identification method for identifying software in accordance with one embodiment of the present invention.

FIG. 2 is a block diagram illustrating a software identification system for selecting software in accordance with an alternate embodiment of the present invention.

FIG. 3 is a flow chart illustrating a software indication process that provides an indication of software corresponding to requested requirements in accordance with another embodiment of the present invention.

FIG. 4 is a block diagram showing an alternate software identification system in accordance with a different embodiment of the present invention.

### BEST MODES FOR CARRYING OUT THE INVENTION

Reference will now be made in detail to the preferred embodiments of the invention, a software identification system and method, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it is understood the present invention may be practiced without these specific details. In other instances, some items have not been described in detail as not to unnecessarily obscure aspects of the current invention.

A software identification system and method in accordance with one embodiment of the present invention facilitates convenient and efficient distribution of software. A user is provided assistance in selecting software that is compatible with a target device or system the user intends to utilize the software with. In most instances, operations associated with selecting and accessing software are performed automatically thereby reducing arduous and error prone user interaction to a minimum. Thus, the user is relieved from performing convoluted tasks requiring a relatively high degree of knowledge and precision with regards to the target device and the software.

A centralized resource receives a request for software and identifies software with features corresponding to the request. The centralized resource includes a software description database that tracks software identification and characteristics of the identified software. The software identification (e.g., a file address) identifies software files stored in a separate software repository. A search for software with characteristics corresponding to the attributes designated in the request or query is performed and potential matching software is identified. A user is not required to have extensive knowledge of numerous different potential software packages and the various features that each software package includes. The software identification system and method automatically compares requested software attributes to available software description characteristics and identifies potential matches. The user does not have to interpret the software features, nor scan through vast amounts of software description information attempting to find a correlation with desired software attributes. A selection process finalizes a software choice and information associated with the choice, including the storage location, is forwarded to the target device. If the target device initiates a file transfer process, the centralized resource communicates software files from the identified storage location of the centralized repository to the target device.

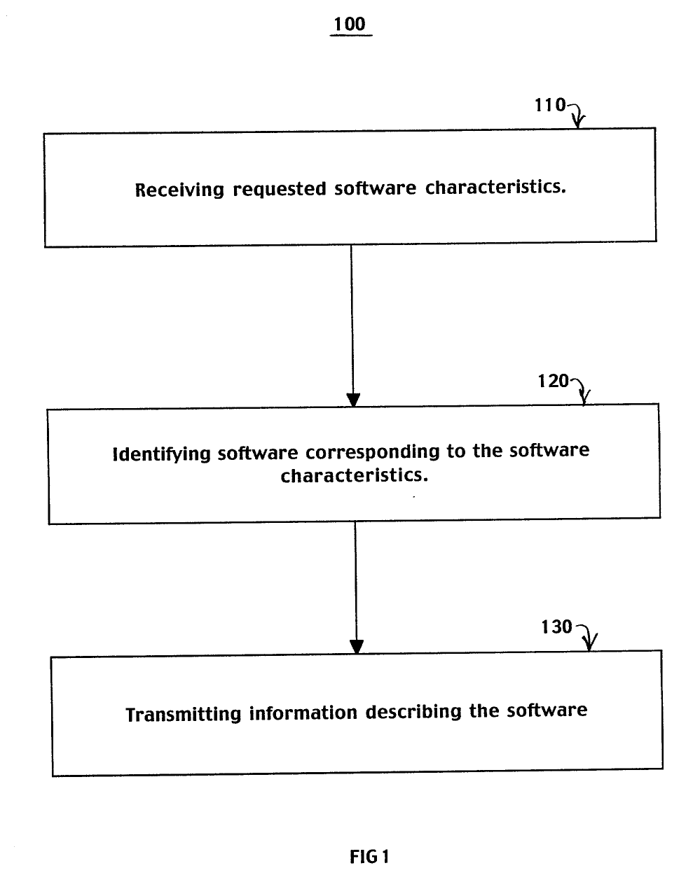

FIG. 1 is a flow chart showing software identification method 100, one embodiment of a present invention method for identifying software. Software identification method 100 engages in automated identification of software for a remote device. The identified software is designed to operably reside on the target system. The identified compatible software is downloaded to a target system attempting to access the software.

In step 110, a query that includes an indication of requested software characteristics is received. The requested software characteristics are included in a parameter list. The parameter list is received from a target device and indicates parameters the software should be compatible with. The parameter list comprises a language identifier, an operating system identifier, and a hardware identifier (e.g., a printer identification). The parameter list is included in a universal resource identifier or locator (URL). The universal resource identifier comprises a landmark universal resource identifier which addresses a system capable of automatically forwarding the parameter list to a location identified by another universal resource identifier.

Software corresponding to the requested software characteristics is identified in step 120. A parameter list received in step 110 is parsed to extract parameters that provide an indication of requested software characteristics. The requested software characteristics are compared to information describing software features and software with corresponding features is identified. The information describing the software features is included in a meta data association component (e.g., a searchable software description database) comprising meta data that includes identification and description of the software (e.g., software name, storage location, features, etc.).

In step 130, information describing the software is transmitted to the device that issued the query received in step 110. The description information is utilized by a target device to access described software via a network. The information includes an indication of a location where the software is stored. The software may be a wide variety of software (e.g., device drivers, firmware images, BIOS information, upgradeable binary components, etc.). In one example, the software is a printer driver and the information describing the software includes an indication of a printer model the software is capable of controlling. The information describing characteristics of the software may also comprise a communications protocol identifier (e.g., ftp, http, etc.), a storage format identifier for the software, an installation method identifier (e.g., an INF installable indication) and software file decompression information.

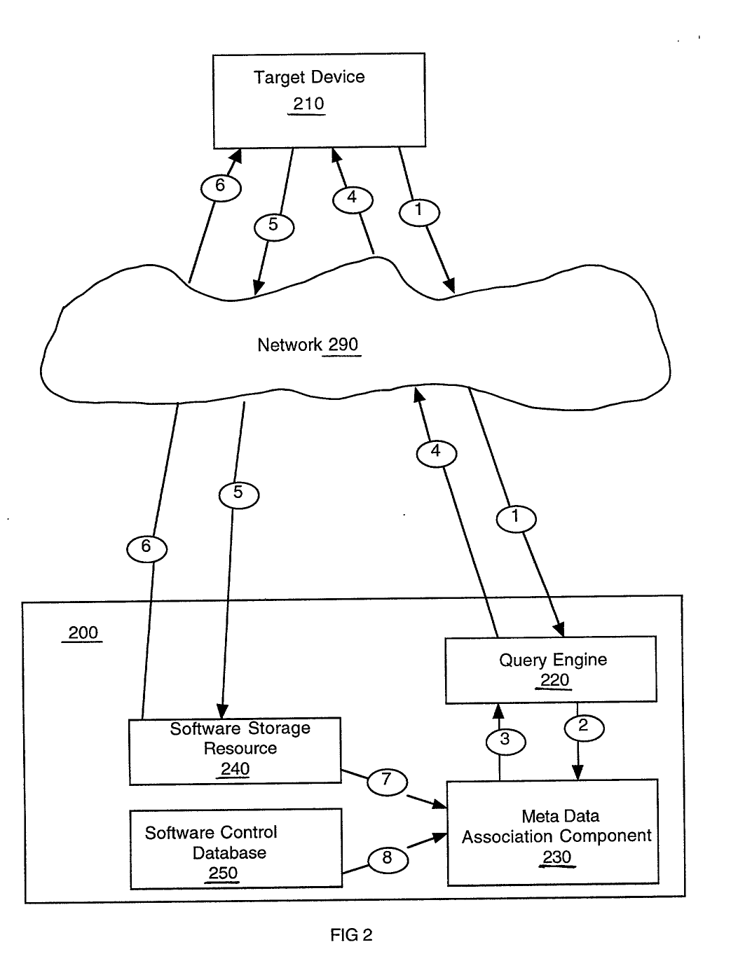

FIG. 2 is a block diagram of a software identification system 200, one embodiment of the present invention. Software identification system 200 facilitates selection and indication of appropriate software compatible with requested requirements. Software identification system 200 comprises a software storage resource 240, meta data association component 230 and query engine 220. Software storage resource 240 is coupled to meta data association component 230 which is coupled to query engine 220. Software identification system 200 also includes optional software control database 250.

The components of software identification system 200 cooperatively operate to facilitate identification of software that corresponds to requested parameters in a query. Software storage resource 240 stores software (e.g., in a software storage database). Meta data association component 230 stores meta data describing characteristics of the software and maps the meta data to the software. Query engine 220 searches the meta data describing characteristics of the software looking for matches with requested parameters. When a match is found, query engine 220 uses the associations provided by meta data association component 230 to extract identification of the software. The search is executed in accordance with a query request from another system. For example, query engine 220 uses query parameters to initiate a dynamic look up against meta data association component 230. Query engine 220 also formulates a meta data reply comprising information indicating software location and features.

A query from target 210 is received by query engine 220 in signal 1 via network 290. The query requests identification of software that corresponds to parameters defined by the query. Query engine 220 searches the software characteristic descriptions included in meta data association component 230 via signal 2 for matches compatible with the parameters received from target 210. When a match is found, query engine 220 extracts an indication of the matching software and its description via signal 3. The indication of the matching software and its features are formulated into a reply that is forwarded to target 210 in signal 4. The matching description includes an indication of the software, its storage location, and its features. If target device 210 whishes to load the software it initiates a file transfer protocol with software storage resource 240 via signal 5 through network 290 and software storage resource forwards the software files via signal 6.

In one embodiment of the present invention, meta data association component 230 automatically accesses information describing software in software storage resource 240 and utilizes it to form meta data stored in meta data association component 230. For example, meta data association component 230 may automatically retrieve descriptive information from software storage resource 240 and software control database 250.

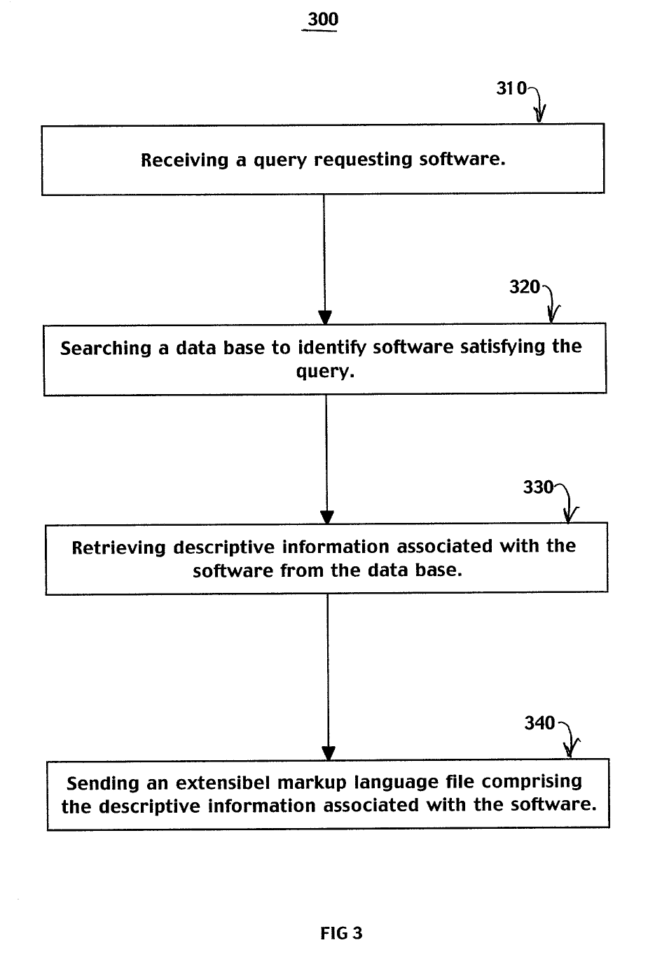

FIG. 3 is a flow chart illustrating software indication process 300, in accordance with one embodiment of the present invention. Instructions for performing software indication process 300 are stored on a computer readable medium. The instructions (e.g., computer readable code) cause a computer system to perform software indication process 300.

In step 310, a query requesting software is received. The query is in the form of a parameter list comprising a description of requested software characteristics. The query is communicated by a Web process in which a call may be redirected (e.g., via a landmark URL) to an appropriate location capable of handing the query. The redirection process relieves calling entities from trying to maintain updated information on query destinations and permits flexible configuration of systems implementing software indication process 300.

A software description database is searched to identify software satisfying the query in step 320. The search looks for a correlation between query requirements and software descriptive information included in the database. The software description database comprises meta data describing software characteristics (e.g., location, compatibility, etc.) and is created in a flexible extensible markup language (XML) format. The software descriptive information included in an information file (e.g., for example a file with a .inf extension) is automatically parsed out and written into the software description database. The database is dynamically updated on regular intervals.

Referring still to FIG. 3, descriptive information associated with the software is retrieved from the database in step 330. The descriptive information comprises a language identifier, an identification of supported hardware (e.g., a printer model name), an identification of a supported operating system, an indication of the software location, an installation method identification and a storage format identification for the software. A meta data description is retrieved from the database and the meta data comprises information that an installer, management application, or other application may require to interact with the described software.

At step 340, an extensible markup language file comprising the descriptive information associated with the software is sent to the target device that issued the query in step 310. Information required for sending the descriptive information is automatically retrieved. For example, firewall and authentication information are retrieved from a target device.

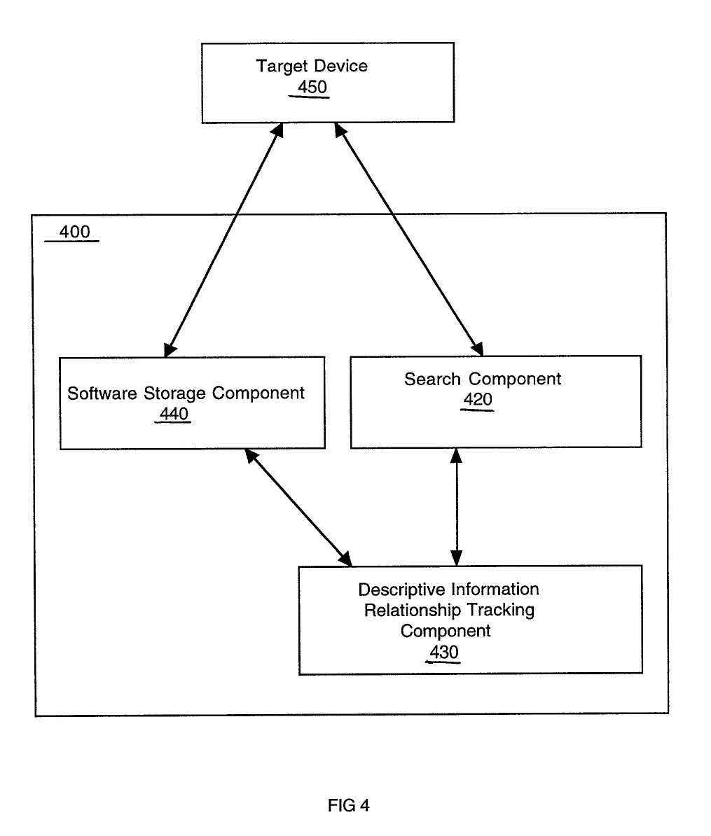

FIG. 4 is a block diagram showing software identification system 400 in accordance with another embodiment of the present invention. Software identification system 400 comprises search component 420, descriptive information relationship tracking component 430, and software storage component 440. Software storage component 440 is coupled to descriptive information relationship tracking component 430 which is coupled to search component 420.

In one exemplary implementation of the present invention, software identification system 400 receives an inquiry from target device 450 about available software. Search component 420 accepts inquires from the public at large (e.g., included in a uniform location identifier) and parses the inquiry. Search parameters are developed based upon attributes indicated in said inquiry and search component 420 searches the software descriptive information for software that has the potential to provide increased performance. The descriptive information is stored in descriptive information relationship tracking component 430 which tracks relationships between software and descriptive information about the software (e.g., software features, location, compatible devices, etc). Descriptive information relationship tracking component 430 is capable of extracting software descriptive information from another database. Search component 420 returns results in an extensible markup language format comprising information indicating software features. For example, name of device drivers that support a device, network location of files for the device driver, and size of the device drivers. Software storage component 440 is capable of forwarding the software via file transfer protocol (e.g., ftp, http, etc.). Software descriptive information forwarded to exterior devices by search component 420 also includes information for decompressing and installing the software.

Thus, the present invention facilitates convenient access to software by automatically identifying software compatible with requested characteristics. The present invention relieves a user from delving into complicated operations associated with identifying and accessing appropriate software for a system (e.g., device drivers for devices included in a system). The user does not have to search through large amounts of perplexing software description information trying to draw correlations to either required or desired software attributes. Resources that incorporate significant expertise automatically select software that matches requested software attributes and provides the selected software in a convenient and efficient manner. Landmark URLs permit meta data associated with the software location may dynamically updated to allow the software to be moved without a calling program needing to track the software movements. The present invention also reduces potential problems associated with user errors by limiting the need for user interaction.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application with the intent of enabling others skilled in the art to utilize the invention and different embodiments, with various modifications as are suited to the particular use contemplated. It is intended that the scope of the invention be defined by the Claims appended hereto and their equivalents.

What is claimed is:

1. A software identification method comprising:
receiving a query that includes an indication of requested software characteristics;
identifying software corresponding to said software characteristics; and
transmitting information describing said software to a device that issued said query.

2. The method as described in claim 1 wherein said information describing said software includes an indication of where said software is stored.

3. The method as described in claim 1 wherein said requested software characteristics are included in a parameter list.

4. The method as described in claim 3 wherein said parameter list is incorporated in a universal resource identifier.

5. The method as described in claim 3 wherein said universal resource identifier comprises a landmark universal resource identifier which addresses a system capable of automatically forwarding said parameter list to a location identified by another universal resource identifier.

6. The method as described in claim 3 wherein said parameter list is parsed to extract an indication of requested software characteristics.

7. The method as described in claim 1 wherein said requested software characteristics include a language identifier, an operating system identifier, and a hardware feature identifier.

8. The method as described in claim 1 wherein said software is a printer driver.

9. The method as described in claim 1 wherein said information describing characteristics of said software includes a communications protocol identifier.

10. The method as described in claim 1 wherein said information describing characteristics of said software includes a storage format identifier for said software.

11. The method as described in claim 1 wherein said information describing characteristics of said software includes installation information.

12. The method as described in claim 1 wherein said information describing characteristics of said software includes software file decompression information.

13. A software identification system comprising:
a software storage resource for storing software;
a meta data association component communicatively coupled to said software storage resource, said meta data association component stores meta data describing characteristics of said software and maps said meta data to said software; and
a query engine communicatively coupled to said meta data association component; said query engine searches said meta data describing characteristics of said software looking for matches with parameters included in said query.

14. The system as described in claim 13 wherein said query engine uses said association provided by said meta data association component to extract identification of said software.

15. The system as described in claim 13 wherein said query engine executes a search in accordance with a query request from another system.

16. The system as described in claim 13 wherein said software storage resource is a software database.

17. The system as described in claim 13 wherein said query engine uses query parameters to initiate a dynamic look up against said software description database.

18. The system as described in claim 13 wherein said query engine formulates a meta data reply comprising information indicating location and features of said software.

19. A computer readable medium having computer readable code embodied therein for causing a computer system to perform a software indication method comprising:
receiving a query requesting software;
searching a database to identify software satisfying said query;
retrieving descriptive information associated with said software from said data base; and
sending an extensible markup language file comprising said descriptive information to a target device that issued said query.

20. The method as described in claim 19 further comprising redirecting a call associated with said query is redirected.

21. The method as described in claim 19 wherein said database comprises meta data describing software characteristics.

22. The method as described in claim 21 wherein said meta data is configured in a extensible markup language format.

23. The method as described in claim 19 wherein said descriptive information comprises a language identifier.

24. The method as described in claim 19 wherein said descriptive information comprises an identification of supported hardware, an identification of a supported operating system, and an indication of said software location.

25. A software identification system comprising:
a means for tracking a relationship between software descriptive information and software; and
a means for searching for a correspondence between said inquiry and said software descriptive information.

26. The system as described in claim 25 wherein said means for searching returns results comprising information indicating location and features of said software.

27. The system as described in claim 26 wherein said results are in an extensible markup language format.

28. The system as described in claim 25 wherein said means for searching accepts inquiries from public resources and develops search parameters based upon attributes indicated in said inquiries.

29. The system as described in claim 28 wherein said inquiries are included in a uniform location identifier.

30. The system as described in claim 25 further comprising a means for storing software, said means for storing said software is capable of forwarding said software via a file transfer protocol.
